(19) United States
(12) Patent Application Publication
(10) Pub. No.: US 2024/0205206 A1
(43) Pub. Date: Jun. 20, 2024

(54) KEY EXCHANGE SYSTEM, TERMINAL, SERVER, KEY EXCHANGE METHOD, AND PROGRAM

(71) Applicant: NIPPON TELEGRAPH AND TELEPHONE CORPORATION, Tokyo (JP)

(72) Inventors: Yuki OKANO, Tokyo (JP); Tetsutaro KOBAYASHI, Tokyo (JP); Keizo MURAKAMI, Tokyo (JP); Tetsuya OKUDA, Tokyo (JP)

(21) Appl. No.: 18/555,615

(22) PCT Filed: May 19, 2021
(86) PCT No.: PCT/JP2021/019016

§ 371 Date: Oct. 16, 2023

(51) Int. Cl. H04L 9/40; H04L 9/06; H04L 9/32

(52) U.S. Cl. CPC H04L 63/061; H04L 9/0643; H04L 9/3213

(57) ABSTRACT

A hey exchange system includes a plurality of terminals that perform key exchange; and a server that performs authentication of each of the terminals and mediation of the key exchange. The server is configured to generate a nonce used when the authentication is performed between the server and the terminal by federation using OpenID Connect; generate a public key and a secret key of token control encryption; transmit the nonce and the public key to the terminal; and decrypt a ciphertext received from the terminal by using the secret key and a token received from the terminal. The terminal is configured to generate a ciphertext obtained b encrypting predetermined data by using the public key and a token generated from the nonce; and transmit the ciphertext to the server.

### TECHNICAL FIELD

The present invention relates to a key exchange system, a terminal, a server, a key exchange method, and a program.

### BACKGROUND ART

A protocol for sharing a key (session key) between a communication terminal that is a session initiator (hereinafter, simply referred to as an “initiator”) and one or more communication terminals that are session responders (hereinafter, simply referred to as “responders”) via a server is known (for example, Non Patent Literatures 1 to 4 and the like). These protocols are server-assisted key exchange protocols, and after the server authenticates each of the initiator and the responder, key exchange is performed between the initiator and the responder when the authentication is successful. In these protocols, the session key can be shared without even being known to the server, so that end-to-end encrypted communication can be achieved between the initiator and the responder.

Each of the above protocols is specifically designed including an authentication manner of the initiator and the responder with respect to the server. For example, the key exchange disclosed in Non Patent Literatures 1, 3, and 5 is a public key based method, and the key exchange disclosed in Non Patent Literature 2 is an ID based method. These authentication methods are completely different from recently widely used “ID/password”, “SMS authentication”, “fingerprint authentication”, “multifactor authentication” in which these authentication methods are combined, and the like. Therefore, in order to increase the degree of freedom of the authentication method, it is required to achieve the server-assisted key exchange by various authentication methods such as “ID/password”, “SMS authentication”, “fingerprint authentication”, and “multifactor authentication”.

Here, a federation protocol called OpenID Connect (hereinafter, also referred to as “OIDC”.) is known (for example, Non Patent Literature 5 and the like). When the initiator and the responder are authenticated to the server using the OIDC ID token, it is possible to achieve the server-assisted key exchange by an arbitrary authentication method required by an ID provider (OP: OpenID Provider).

### CITATION LIST

### Non Patent Literature

Non Patent Literature 1: Kazuki Yoneyama, Reo Yoshida, Yuto Kawahara, Tetsutaro Kobayashi, Hitoshi Fuji, Tomohide Yamamoto, “Multi-Cast Key Distribution:Scalable, Dynamic and Provably Secure Construction,” International Conference on Provable Security (ProvSec 2016), LNCS10005, pp. 207-226, November 2016.
Non Patent Literature 2: Yoneyama, Kazuki, et al. “Exposure-Resilient Identity-Based Dynamic Multi-Cast Key Distribution.” IEICE TRANSACTIONS on Fundamentals of Electronics, Communications and Computer Sciences 101.6 (2018):929-944.
Non Patent Literature 3: Boyd, Colin, et al. “Offline assisted group key exchange.” International Conference on Information Security. Springer, Cham, 2018.
Non Patent Literature 4: Cohn-Gordon, Katriel, et al. “A Formal Security Analysis of the Signal Messaging Protocol.” 2017 IEEE European Symposium on Security and Privacy (EuroS&P). IEEE, 2017.
Non Patent Literature 5: OpenID Connect Core 1.0 incorporating errata set 1, Internet <URL: http://openid-foundation-japan.github.io/openid-connect-core-1_0.ja.html>

### SUMMARY OF INVENTION

### Technical Problem

However, in the protocol disclosed in Non Patent Literatures 1 to 4, authentication is performed on the server every time key exchange is performed. For this reason, when the OIDC is simply applied to these protocols, it is necessary to perform authentication with the ID provider each time a key exchange is performed, which is inefficient.

An embodiment of the present invention has been made in view of the above points, and an object thereof is to implement efficient server-assisted key exchange using any authentication method.

### Solution to Problem

In order to achieve the above object, a key exchange system according to an embodiment includes: a plurality of terminals that perform key exchange; and a server that performs authentication of each of the terminals and mediation of the key exchange, in which the server includes a nonce generation unit that generates a nonce used when the authentication is performed between the server and the terminal by federation using OpenID Connect, a key generation unit that generates a public key and a secret key of token control encryption, a first transmission unit that transmits the nonce and the public key to the terminal, and a decryption unit that decrypts a ciphertext received from the terminal by using the secret key and a token received from the terminal, and the terminal includes an encryption unit that generates a ciphertext obtained by encrypting predetermined data by using the public key and a token generated from the nonce, and a second transmission unit that transmits the ciphertext to the server.

### Advantageous Effects of Invention

It is possible to achieve efficient server-assisted key exchange using any authentication method.

### BRIEF DESCRIPTION OF DRAWINGS

FIG. 1 is a diagram illustrating an example overall configuration of a key exchange system according to the present embodiment.

FIG. 2 is a diagram illustrating an example of a functional configuration of the terminal according to the present embodiment.

FIG. 3 is a diagram illustrating an example of a functional configuration of the server according to the present embodiment.

FIG. 4 is a sequence diagram illustrating an example of federation (implicit flow) and key exchange processing according to the present embodiment.

FIG. 5 is a sequence diagram illustrating an example of federation (authorization code flow) and key exchange processing according to the present embodiment.

FIG. 6 is a diagram illustrating an example of a hardware configuration of a computer.

### DESCRIPTION OF EMBODIMENTS

Hereinafter, an embodiment of the present invention will be described. In the present embodiment, a description will be given of a key exchange system 1 in which any authentication method can be used by the OIDC, and efficient server-assisted key exchange that does not require re-authentication even at the time of a plurality of key exchange sessions can be achieved.

### <Preparation>

First, an encryption scheme used in the present embodiment is prepared.

### <<Public Key Encryption>>

Public key encryption is composed of the following set of three algorithms (KeyGen, Enc, Dec).

KeyGen(1^{κ})→(pk, sk): A key generation algorithm that receives a one-bit string 1^{κ} of a security parameter κ length as an input and outputs a key pair (pk, sk) of a public key pk and a secret key sk.

Enc (pk, m)→C: An encryption algorithm that receives the public key pk and a message m as inputs and outputs a ciphertext C.

Dec (sk, C)→m′: A decryption algorithm that receives the secret key sk and the ciphertext C as inputs and outputs a message m′.

The public key encryption also requires the following conditions as validity.

Validity condition: For any security parameter κ, any key pair (pk, sk)←KeyGen(1^{κ}), and any message m, Dec (sk, Enc (pk, m))=m holds.

### <<Token Control Public Key Encryption>>

Token control public key encryption is composed of the following set of three algorithms (TKeyGen, TEnc, TDec).

TKeyGen(1^{κ})→(pk, sk): A key generation algorithm that receives a one-bit string 1^{κ} of a security parameter κ length as an input and outputs a key pair (pk, sk) of a public key pk and a secret key sk.

TEnc (pk, m, token)→C: An encryption algorithm that receives the public key pk, the message m, and a token token as inputs and outputs the ciphertext C.

TDec (sk, C, token)→m′: A decryption algorithm that receives the secret key sk, the ciphertext C, and the token token as inputs and outputs the message m′.

The token control public key encryption also requires the following conditions as validity.

Validity condition: For any security parameter κ, any key pair (pk, sk)←TKeyGen(1^{κ}), any token token, and any message m, TDec (sk, TEnc (pk, m, token))=m holds.

Examples of token control public key encryption include an encryption scheme described in Reference Document 1 “Galindo, David, and Javier Herranz. “A generic construction for tokencontrolled public key encryption.” International Conference on Financial Cryptography and Data Security. Springer, Berlin, Heidelberg, 2006.”.

### <Overall Configuration>

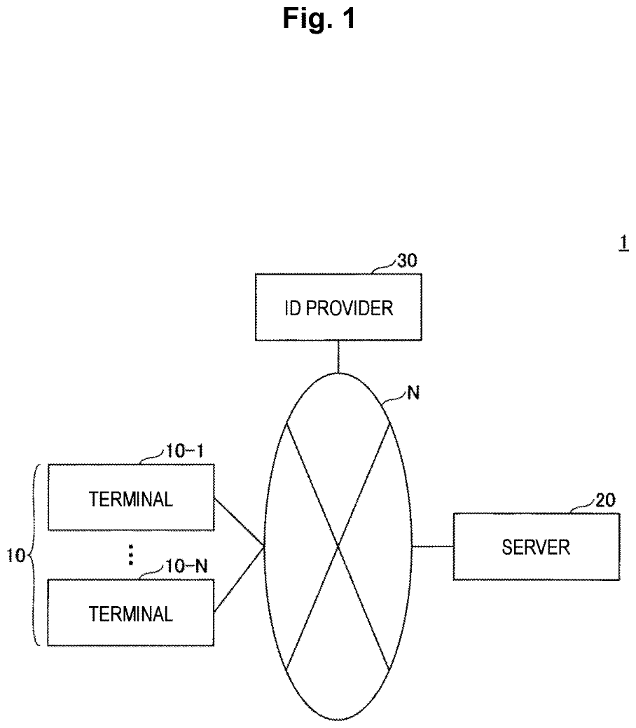

Next, an overall configuration of the key exchange system 1 according to the present embodiment will be described with reference to FIG. 1. FIG. 1 is a diagram illustrating an example overall configuration of the key exchange system 1 according to the present embodiment.

As illustrated in FIG. 1, the key exchange system 1 according to the present embodiment includes a plurality of terminals 10, a server 20, and an ID provider 30. These are communicably connected via a communication network N such as the Internet. Hereinafter, each of the terminals 10 that perform key exchange is referred to as a “terminal 10-1”, . . . , and a “terminal 10-N”. Here, N (where N≥2) is the total number of terminals.

The terminal 10 is a user terminal that performs key exchange with one or more other terminals 10 using a server-assisted key exchange protocol. Here, among the plurality of terminals 10, there is one terminal 10 serving as an initiator and one or more terminals 10 serving as responders.

Examples of the terminal 10 include various apparatuses and devices such as a general-purpose server, a personal computer (PC), a smartphone, a tablet terminal, a wearable device, an in-vehicle device, an industrial device, a home appliance, and a robot.

The server 20 is a server that supports key exchange when the key exchange is performed between the plurality of terminals 10 by a server-assisted key exchange protocol (that is, mediates the key exchange between the plurality of terminals 10). Here, as described above, when key exchange is performed among the plurality of terminals 10, the server 20 needs to authenticate (signature verification, encryption, or the like) each of the terminals 10. In the present embodiment, this authentication is performed by token control public key encryption using a nonce used in OIDC as a token. As a result, each terminal 10 can be authenticated by an arbitrary authentication scheme requested by the OP, and authentication can be performed by token control public key encryption using the same nonce within the valid period of the ID token of the OIDC (alternatively, within a valid period designated by the server 20). Therefore, it is not necessary to perform re-authentication at the time of executing each key exchange session within the valid period, and efficient key exchange is achieved.

The ID provider 30 is a server or the like that functions as an OP of the OIDC. The ID provider 30 requests the terminal 10 to perform user authentication according to a predetermined arbitrary authentication scheme.

### <Functional Configuration>

Next, a functional configuration of the terminal 10 and the server 20 according to the present embodiment will be described.

### <<Terminal 10>>

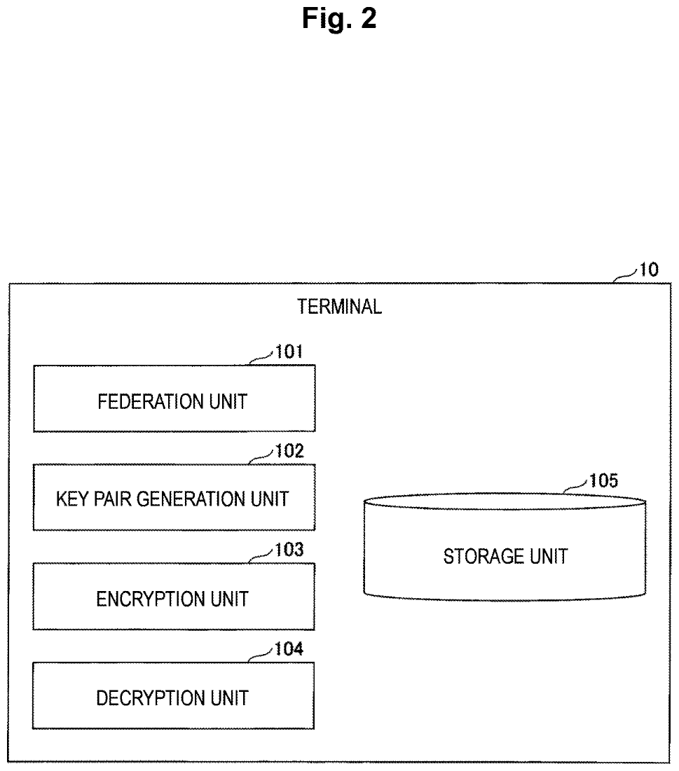

A functional configuration of the terminal 10 according to the present embodiment will be described with reference to FIG. 2. FIG. 2 is a diagram illustrating an example of a functional configuration of the terminal 10 according to the present embodiment.

As illustrated in FIG. 2, the terminal 10 according to the present embodiment includes a federation unit 101, a key pair generation unit 102, an encryption unit 103, and a decryption unit 104. For example, each unit is implemented by a processor such as a central processing unit (CPU) executes one or more programs installed in the terminal 10.

In addition, the terminal 10 according to the present embodiment includes a storage unit 105. The storage unit 105 is implemented by, for example, various memory devices such as a hard disk drive (HDD), a solid state drive (SSD), or flash memory.

The federation unit 101 performs various processes for performing federation by the OIDC. The key pair generation unit 102 executes the key generation algorithm KeyGen to generate a key pair of own public key and secret key of the terminal 10. The encryption unit 103 executes the encryption algorithm TEnc using the hash value of the nonce used in the OIDC as a token to generate a ciphertext. The decryption unit 104 executes the decryption algorithm Dec to decrypt the ciphertext. The storage unit 105 stores information necessary for each of the above units to execute various processes, execution results thereof, and the like (for example, various keys, nonce, or ID token).

### <<Server 20>>

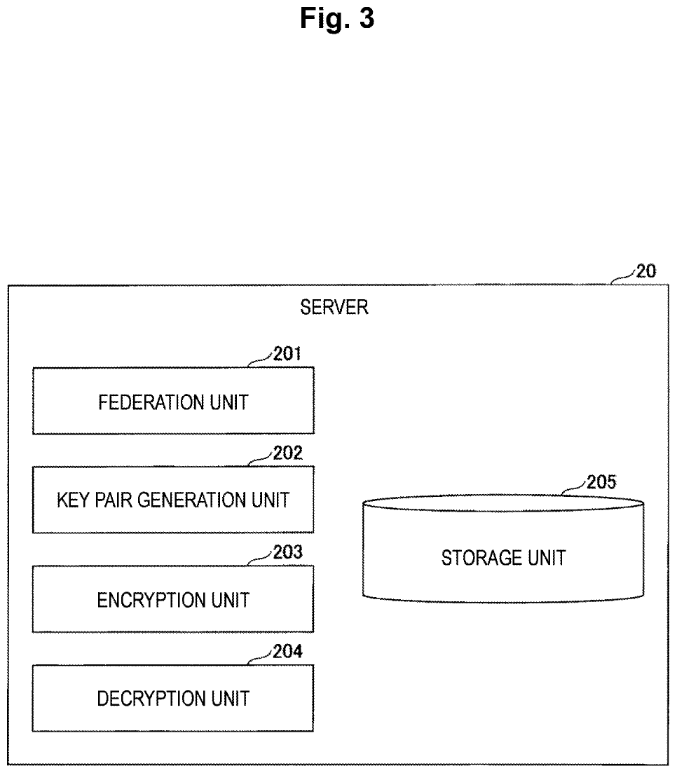

A functional configuration of the server 20 according to the present embodiment will be described with reference to FIG. 3. FIG. 3 is a diagram illustrating an example of a functional configuration of the server 20 according to the present embodiment.

As illustrated in FIG. 3, the server 20 according to the present embodiment includes a federation unit 201, a key pair generation unit 202, an encryption unit 203, and a decryption unit 204. Each of these units is implemented, for example, by processing executed by the processor such as a CPU by one or more programs installed in the server 20.

In addition, the server 20 according to the present embodiment includes a storage unit 205. The storage unit 205 is implemented by, for example, various memory devices such as an HDD, an SSD, and a flash memory. The storage unit 205 may be implemented by, for example, a storage device connected to the server 20 via the communication network.

The federation unit 201 performs various processes for performing federation by the OIDC. In particular, the federation unit 201 generates a nonce used in the OIDC. The key pair generation unit 202 executes the key generation algorithm TKeyGen to generate a key pair of public key and secret key of the server. The encryption unit 203 executes the encryption algorithm Enc to generate a ciphertext. The decryption unit 204 executes the decryption algorithm TDec to decrypt the ciphertext. At this time, the decryption unit 204 decrypts the ciphertext by using the hash value of the nonce generated by the server 20. The storage unit 205 stores information necessary for each of the above units to execute various processes, execution results thereof, and the like (for example, various keys, nonce, or ID token).

### <Federation and Key Exchange Processing>

Hereinafter, the federation and the key exchange processing according to the present embodiment will be described. Here, since there are an authentication flow called an implicit flow and an authentication flow called an authorization code flow in the OIDC, a case where the authentication flow is the implicit flow and a case where the authentication flow is the authorization code flow will be described. When the authentication flow is an implicit flow, the terminal 10 and the server 20 correspond to a relying party (RP), and when the authentication flow is an authorization code flow, the server 20 corresponds to the RP.

<<Case where Federation is Implicit Flow>>

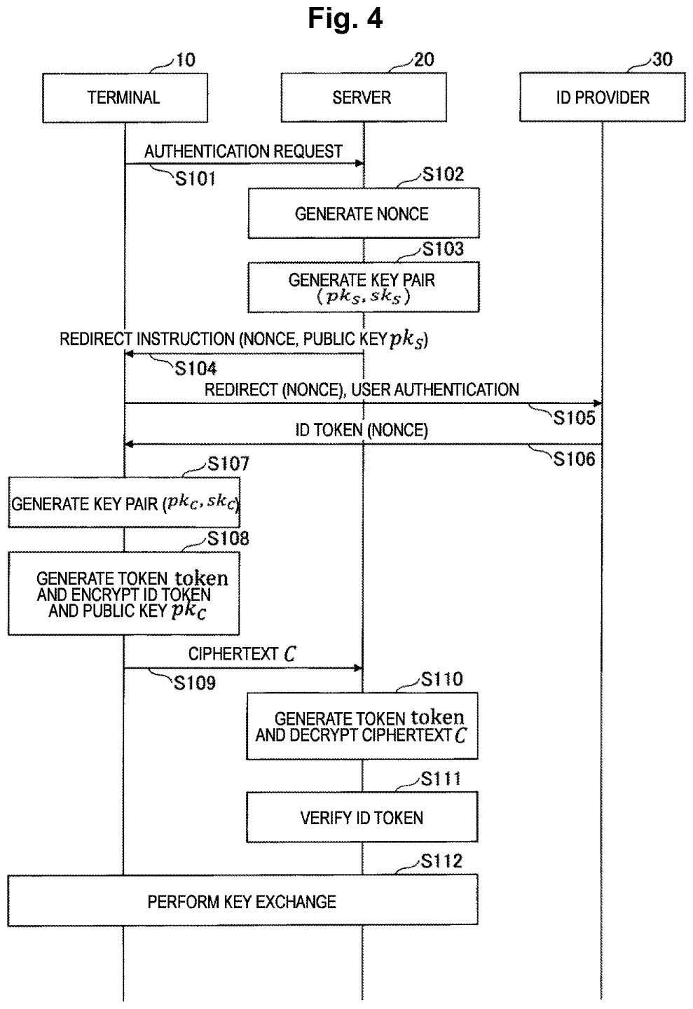

The federation and the key exchange processing when the authentication flow is the implicit flow will be described with reference to FIG. 4. FIG. 4 is a sequence diagram illustrating an example of federation (implicit flow) and key exchange processing according to the present embodiment.

The federation unit 101 of the terminal 10 transmits an authentication request to the server 20 (step S101).

Upon receiving the authentication request, the federation unit 201 of the server 20 generates a nonce nonce used in the OIDC (step S102). The key pair generation unit 202 of the server 20 generates a key pair (pkₛ, skₛ) of the public key pkₛ and the secret key skₛ by TKeyGen (1^{κ})→(pkₛ, skₛ) (step S103). Subsequently, the federation unit 201 of the server 20 transmits a redirection instruction to the ID provider 30 to the terminal 10 (step S104). At this time, the federation unit 201 includes the nonce nonce and the public key pkₛ in the redirection instruction.

Upon receiving the redirection instruction, the federation unit 101 of the terminal 10 redirects to the ID provider 30, and performs user authentication by the authentication scheme requested by the ID provider 30 (step S105). At this time, the federation unit 101 transmits the nonce nonce to the ID provider 30 at the time of user authentication. Examples of the authentication method requested by the ID provider 30 include various authentication methods such as “ID/password”, “SMS authentication”, “fingerprint authentication”, and “multi-factor authentication”.

In a case where the user authentication described above is successful, an ID token with a signature and a nonce by the ID provider 30 is returned from the ID provider 30 to the terminal 10 (step S106).

Upon receiving the ID token from the ID provider 30, the key pair generation unit 102 of the terminal 10 generates a key pair (pk_{c}, sk_{c}) of the public key pk_{c} and the secret key sk_{c} by KeyGen (1^{κ})→(pk_{c}, sk_{c}) (step S10⁷). Next, the encryption unit 103 of the terminal 10 generates a ciphertext C obtained by encrypting the message m including the ID token and the public key pk_{c} with the public key pkₛ using the hash value obtained by inputting the nonce nonce to a predetermined hash function (for example, SHA-256 or the like) as the token token (step S108). That is, the encryption unit 103 generates the ciphertext C by TEnc(pkₛ, m, token)→C. Then, the encryption unit 103 of the terminal 10 transmits the ciphertext C to the server 20 (step S109).

Upon receiving the ciphertext C, the decryption unit 204 of the server 20 decrypts the ciphertext C with the secret key skₛ using a hash value obtained by inputting the nonce nonce to a predetermined hash function (for example, SHA-256 or the like) as the token token (step S110). That is, the decryption unit 204 decrypts the ciphertext C using TDec(skₛ, C, token)→m to obtain the message m. As a result, the ID token and the public key pk_{c} are obtained from the message m.

The federation unit 201 of the server 20 verifies the ID token obtained in step S110 (step S111). That is, after verifying the signature of the ID token, the federation unit 201 verifies that the nonce given to the ID token matches the nonce nonce generated in step S102 described above.

In a case where the verification in step S111 described above is successful, the terminal 10 and the server 20 perform key exchange (step S112). Details of this key exchange will be described later.

<<Case where Federation is Authorization Code Flow>>

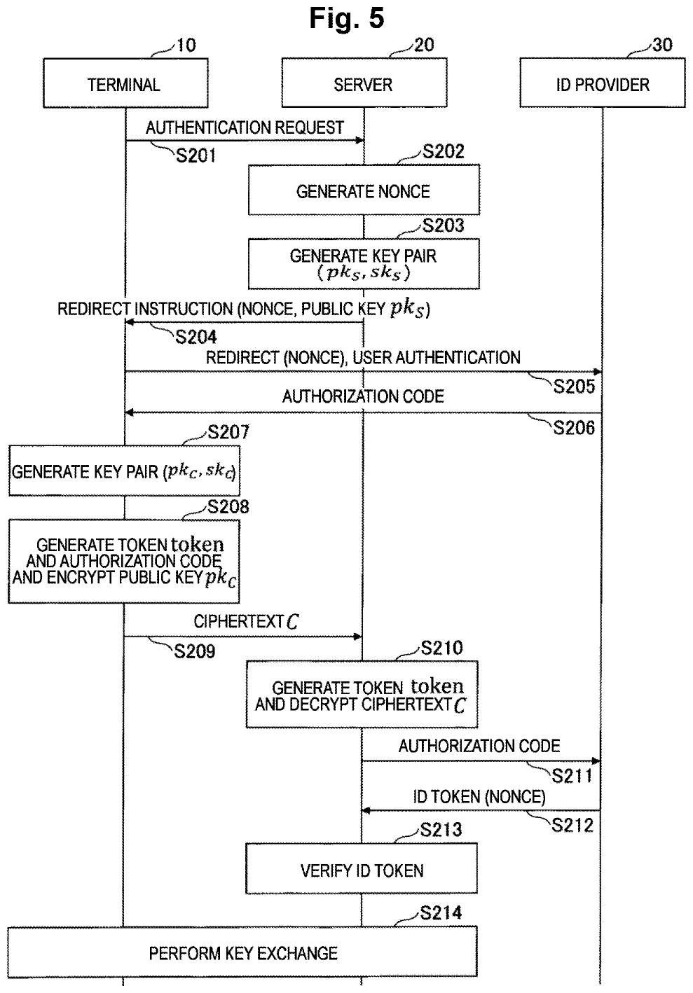

The federation and the key exchange processing when the federation is the authorization code flow will be described with reference to FIG. 5. FIG. 5 is a sequence diagram illustrating an example of federation (authorization code flow) and key exchange processing according to the present embodiment.

The federation unit 101 of the terminal 10 transmits an authentication request to the server 20 (step S201).

Upon receiving the authentication request, the federation unit 201 of the server 20 generates a nonce nonce used in the OIDC (step S202). The key pair generation unit 202 of the server 20 generates a key pair (pkₛ, skₛ) of the public key pkₛ and the secret key skₛ; by TKeyGen (1^{κ})→(pkₛ, skₛ) (step S203). Subsequently, the federation unit 201 of the server 20 transmits a redirection instruction to the ID provider 30 to the terminal 10 (step S204). At this time, the federation unit 201 includes the nonce nonce and the public key pk_{c} in the redirection instruction.

Upon receiving the redirection instruction, the federation unit 101 of the terminal 10 redirects to the ID provider 30, and performs user authentication by the authentication scheme requested by the ID provider 30 (step S205). At this time, the federation unit 101 transmits the nonce nonce to the ID provider 30 at the time of user authentication.

In a case where the user authentication described above is successful, an authorization code is returned from the ID provider 30 to the terminal 10 (step S206).

Upon receiving the authorization code from the ID provider 30, the key pair generation unit 102 of the terminal 10 generates a key pair (pk_{c}, sk_{c}) of the public key pk_{c} and the secret key sk, by KeyGen (1^{κ})→(pk_{c}, sk_{c}) (step S207). Next, the encryption unit 103 of the terminal 10 generates a ciphertext C obtained by encrypting the message m including the authorization code and the public key pk_{c} with the public key pkₛ using the hash value obtained by inputting the nonce nonce to a predetermined hash function (for example, SHA-256 or the like) as the token token (step S208). That is, the encryption unit 103 generates the ciphertext C by TEnc(pkₛ, m, token)→C. Then, the encryption unit 103 of the terminal 10 transmits the ciphertext C to the server (step S209).

Upon receiving the ciphertext C, the decryption unit 204 of the server 20 decrypts the ciphertext C with the secret key skₛ using a hash value obtained by inputting the nonce nonce to a predetermined hash function (for example, SHA-256 or the like) as the token token (step S210). That is, the decryption unit 204 decrypts the ciphertext C using TDec(skₛ, C, token)→m to obtain the message m. As a result, the authorization code and the public key pk_{c} are obtained from the message m.

Next, the federation unit 201 of the server 20 transmits the authorization code obtained in step S210 to the ID provider 30 (step S211). As a result, an ID token with a signature and a nonce by the ID provider 30 is returned from the ID provider 30 to the server 20 (step S212).

The federation unit 201 of the server 20 verifies the ID token obtained in step S212 (step S213). That is, after verifying the signature of the ID token, the federation unit 201 verifies that the nonce given to the ID token matches the nonce nonce generated in step S202 described above.

In a case where the verification in step S213 described above is successful, the terminal 10 and the server 20 perform key exchange (step S214). Details of this key exchange will be described later.

### <<Key Exchange Processing (Example 1)>>

As Example 1 of the key exchange in step S112 or step S214 described above, a case where the key exchange disclosed in Non Patent Literatures 1 and 2 is performed will be described. For processing other than the processing specifically described below, refer to Non Patent Literatures 1 and 2.

In the key exchange disclosed in Non Patent Literatures 1 and 2, first, a MAC key and a key of attribute-based encryption are transmitted from the server 20 to the terminal 10. At this time, the encryption unit 203 of the server 20 generates a ciphertext C obtained by encrypting the message m′ including these keys with the public key pk_{c}, that is, generates the ciphertext C by Enc (pk_{c}, m′)→C, and transmits the ciphertext C to the terminal 10. Then, the decryption unit 104 of the terminal 10 decrypts the ciphertext C, that is, generates a message m′ by Dec(sk_{c}, C)→m′, and extracts the MAC key and the key of the attribute-based encryption from the message m′. Subsequent processing is similar to the processing disclosed in Non Patent Literatures 1 and 2. As a result, the terminal 10 can execute the key exchange protocol without performing user authentication again by the ID provider 30 as long as it is within the valid period of the ID token (alternatively, within the valid period designated by the server 20).

### <<Key Exchange Processing (Example 2)>>

As Example 2 of the key exchange in step S112 or step S214 described above, a case where the key exchange disclosed in Non Patent Literature 3 is performed will be described. For processing other than the processing specifically described below, refer to Non Patent Literature 3.

A Case where the Terminal 10 Performs Key Exchange as an Initiator

Here, changes from FIG. 10 disclosed in Non Patent Literature 3 will be described. When transmitting a message (this message is m′.) including a nonce N_{T} and a partner identifier pid from the terminal 10 to the server 20 in Stage 1, the encryption unit 103 of the terminal 10 generates a ciphertext C obtained by encrypting the message m′ with the public key pkₛ using a hash value obtained by inputting the nonce nonce used in the OIDC to a predetermined hash function (for example, SHA-256 or the like) as the token token, that is, generates the ciphertext C by TEnc (pkₛ, m′, token) C, and transmits the ciphertext C to the server 20. Upon receiving the ciphertext C, the decryption unit 204 of the server 20 decrypts the ciphertext C with the secret key skₛ, that is, generates a message m′ by TDec(skₛ, C, token)→m′ using a hash value obtained by inputting the nonce nonce used in the OIDC to a predetermined hash function (for example, SHA-256 or the like) as the token token, and extracts the nonce N₁ and the partner identifier pid from the message m′. In this manner, the server 20 authenticates the terminal 10 by being able to decrypt with the token token. Subsequent processing is similar to FIG. 10 disclosed in Non Patent Literature 3.

A Case where the Terminal 10 Performs Key Exchange as a Responder

Similarly, changes from FIG. 10 disclosed in Non Patent Literature 3 will be described. When transmitting a message (this message is m″.) including a Blined ciphertext C^{˜} (precisely, ˜ is denoted on the letter C) and a session identifier sid from the terminal 10 to the server 20 in Stage 3, the encryption unit 103 of the terminal 10 generates a ciphertext C obtained by encrypting the message m″ with the public key pkₛ using a hash value obtained by inputting the nonce nonce used in the OIDC to a predetermined hash function (for example, SHA-256 or the like) as the token token, that is, generates the ciphertext C by TEnc (pkₛ, m″, token)→C, and transmits the ciphertext C to the server 20. Upon receiving the ciphertext C, the decryption unit 204 of the server 20 decrypts the ciphertext C with the secret key skₛ, that is, generates a message m″ by TDec(skₛ, C, token)→m″ using a hash value obtained by inputting the nonce nonce used in the OIDC to a predetermined hash function (for example, SHA-256 or the like) as the token token, and extracts the Blined ciphertext C^{˜} and the session identifier sid from the message m″. In this manner, the server 20 authenticates the terminal 10 by being able to decrypt with the token token. Subsequent processing is similar to FIG. 10 disclosed in Non Patent Literature 3.

### <<Key Exchange Processing (Example 3)>>

As Example 3 of the key exchange in step S112 or step S214 described above, a case where the key exchange disclosed in Non Patent Literature 4 is performed will be described. For processing other than the processing specifically described below, refer to Non Patent Literature 4.

A Case where the Terminal 10 Performs Key Exchange as an Initiator

Here, changes from FIG. 1 disclosed in Non Patent Literature 4 will be described. In this case, the terminal 10 is regarded as Alice, and the communication partner is regarded as Bob.

In (b) of FIG. 1, when transmitting a message (this message is m′.) including an identifier of a communication partner from the terminal 10 to the server 20, the encryption unit 103 of the terminal 10 generates a ciphertext C obtained by encrypting the message m′ with the public key pkₛ using a hash value obtained by inputting the nonce nonce used in the OIDC to a predetermined hash function (for example, SHA-256 or the like) as the token token, that is, generates the ciphertext C by TEnc (pkₛ, m′, token)→C, and transmits the ciphertext C to the server 20. Upon receiving the ciphertext C, the decryption unit 204 of the server 20 decrypts the ciphertext C with the secret key skₛ, that is, generates a message m′ by TDec(skₛ, C, token)→m′ using a hash value obtained by inputting the nonce nonce used in the OIDC to a predetermined hash function (for example, SHA-256 or the like) as the token token, and extracts the identifier of the communication partner from the message m′. In this manner, the server 20 authenticates the terminal 10 by being able to decrypt with the token token. Subsequent processing is similar to FIG. 1 disclosed in Non Patent Literature 4.

A Case where the Terminal 10 Performs Key Exchange as a Responder

Similarly, changes from FIG. 1 disclosed in Non Patent Literature 4 will be described. In this case, the terminal 10 is regarded as Bob, and the communication partner is regarded as Alice.

In (a) of FIG. 1, when transmitting a message (this message is m′.) including public key, pre-public key with signature, and a plurality of temporary secret key of the terminal 10 from the terminal 10 to the server 20, the encryption unit 103 of the terminal 10 generates a ciphertext C obtained by encrypting the message m″ with the public key pkₛ using a hash value obtained by inputting the nonce nonce used in the OIDC to a predetermined hash function (for example, SHA-256 or the like) as the token token, that is, generates the ciphertext C by TEnc (pkₛ, m″, token)→C, and transmits the ciphertext C to the server 20. Upon receiving the ciphertext C, the decryption unit 204 of the server 20 decrypts the ciphertext C with the secret key skₛ, that is, generates a message m′ by TDec(skₛ, C, token)→m″ using a hash value obtained by inputting the nonce nonce used in the OIDC to a predetermined hash function (for example, SHA-256 or the like) as the token token, and extracts the public key, pre-public key with signature, and plurality of temporary secret keys of the terminal 10 from the message m″. In this manner, the server 20 authenticates the terminal 10 by being able to decrypt with the token token. Subsequent processing is similar to FIG. 1 disclosed in Non Patent Literature 4.

As described above, in a case where a session key is shared and encrypted communication is performed using the server-assisted key exchange protocol disclosed in Non Patent Literatures 1 to 4 and the like, authentication can be performed by any authentication scheme requested by the OP, and re-authentication at the time of executing each key exchange session becomes unnecessary within a predetermined valid period, so that efficient key exchange can be achieved. In addition, since it is not necessary to manage the secret key on the terminal 10 side which has been required so far, it is possible to perform the server-assisted key exchange from a plurality of different terminals 10, a browser, and the like depending on the authentication scheme requested by the OP.

### <Hardware Configuration>

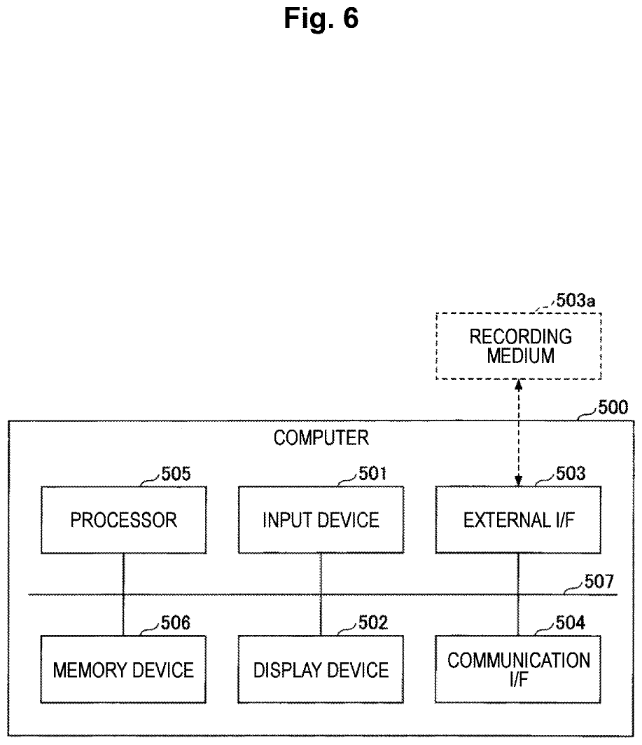

Lastly, a hardware configuration of the terminal 10 and the server 20 according to the present embodiment will be described. The terminal 10 and the server 20 in the present embodiment are implemented by, for example, a hardware configuration of a computer 500 illustrated in FIG. 6. FIG. 6 is a diagram illustrating an example of a hardware configuration of the computer 500.

The computer 500 illustrated in FIG. 6 includes an input device 501, a display device 502, an external I/F 503, a communication i/F 504, a processor 505, and a memory device 506. These pieces of hardware are communicably connected by a bus 507.

The input device 501 is, for example, a keyboard, a mouse, a touch panel, or the like. The display device 502 is, for example, a display or the like. Note that the computer 500 may not include at least one of the input device 501 or the display device 502, for example.

The external I/F 503 is an interface with an external device such as a recording medium 503a. The computer 500 can read or write the recording medium 503a via the external I/F 503. Note that examples of the recording medium 503a include a compact disc (CD), a digital versatile disk (DVD), a secure digital memory card (SD memory card), a universal serial bus (USB) memory card, and the like.

The communication I/F 504 is an interface for connecting the computer 500 to a communication network. The processor 505 is one of various arithmetic devices such as a CPU, for example. The memory device 506 is, for example, a storage device of various types such as a HDD, an SSD, a flash memory, a random access memory (RAM), and a read only memory (ROM).

The terminal 10 and the server 20 according to the present embodiment has the hardware configuration illustrated in FIG. 6, thereby being able to implement the above-described federation and key exchange processing. Note that the hardware configuration illustrated in FIG. 6 is an example, and, for example, the computer 500 may include a plurality of processors or may include a plurality of memory devices, and may include various hardware configurations.

The present invention is not limited to the above embodiment specifically disclosed, and various modifications and changes, combinations with known technologies, and the like can be made without departing from the scope of the claims.

### REFERENCE SIGNS LIST

1 Key exchange system
10 Terminal
20 Server
30 ID provider
101 Federation unit
102 Key pair generation unit
103 Encryption unit
104 Decryption unit
105 Storage unit
201 Federation unit
202 Key pair generation unit
203 Encryption unit
204 Decryption unit
205 Storage unit
N Communication network

1. A key exchange system comprising: a plurality of terminals that perform key exchange; and a server that performs authentication of each of the terminals and mediation of the key exchange, wherein
the server is configured to:
generate a nonce used when the authentication is performed between the server and the terminal by federation using OpenID Connect,
generate a public key and a secret key of token control encryption,
transmit the nonce and the public key to the terminal and
decrypt a ciphertext received from the terminal by using the secret key and a token received from the terminal, and
the terminal is configured to
generate a ciphertext obtained by encrypting predetermined data by using the public key and a token generated from the nonce, and
transmit the ciphertext to the server.

2. The key exchange system according to claim 1, wherein
in the server,
it is assumed that authentication of the terminal is successful in a case where the ciphertext is correctly decrypted, and it is assumed that authentication of the terminal fails in a case where the ciphertext cannot be decrypted.

3. The key exchange system according to claim 1, wherein
the terminal is configured to calculate a hash value of the nonce using a predetermined hash function, and
the terminal
generates the ciphertext by using the hash value as the token.

4. A terminal connected to another terminal that performs key exchange and a server that performs authentication of each terminal and mediation of the key exchange via a communication network, the terminal comprising:
a processor; and
a memory storing program instructions that cause the processor to:
generate a ciphertext obtained by encrypting predetermined data, using a public key of token control encryption and generated by the server, and a token generated from a nonce used when the authentication is performed between the terminal and the server by federation using OpenID Connect; and
transmit the ciphertext to the server.

5. (canceled)

6. A key exchange method used in a key exchange system including a plurality of terminals that perform key exchange and a server that performs authentication of each of the terminals and mediation of the key exchange,
the key exchange method comprising steps performed by the server, the steps including:
generating a nonce used when the authentication is performed between the server and the terminal by federation using OpenID Connect;
generating a public key and a secret key of token control encryption;
transmitting the nonce and the public key to the terminal; and
decrypting a ciphertext received from the terminal by using the secret key and a token received from the terminal,
the key exchange method further comprising steps performed by the terminal, the steps including:
generating a ciphertext obtained by encrypting predetermined data by using the public key and a token generated from the nonce; and
transmitting the ciphertext to the server.

7. A non-transitory computer-readable recording medium having stored therein a program for causing the server and the terminal to perform the key exchange method according to claim 6.
